(19) United States
(12) Patent Application Publication
(10) Pub. No.: US 2014/0104047 A1
(43) Pub. Date: Apr. 17, 2014

(54) DISPLAY DEVICE HAVING A DEFORMABLE SURFACE AND POSITION SENSORS

(71) Applicants: Christian Bolzmacher, Montrouge (FR); Moustapha Hafez, Arcueil (FR)

(72) Inventors: Christian Bolzmacher, Montrouge (FR); Moustapha Hafez, Arcueil (FR)

(73) Assignee: COMMISSARIAT A L'ENERGIE ATOMIQUE ET AUX ENE ALT, Paris (FR)

(21) Appl. No.: 14/119,307

(22) PCT Filed: May 24, 2012
(86) PCT No.: PCT/FR12/51170

§ 371 Date: Nov. 21, 2013

(30) Foreign Application Priority Data
May 30, 2011 (FR) 11 54723

(51) Int. Cl. G06F 3/01

(52) U.S. Cl. CPC G06F 3/016
USPC 340/407.2

(57) ABSTRACT

A tactile display device including: a touch screen including ferromagnetic particles; a plurality of actuators including magnet elements distributed against the touch screen; a mechanism for activating each actuator to generate a local magnetic field in the touch screen; and an elastic membrane formed in an elastomer flexible solid material, the elastomer material including the ferromagnetic particles.

The present invention concerns a tactile display device with a screen provided with ferromagnetic particles.

More precisely, the invention concerns a device of the type comprising:

a touch screen comprising ferromagnetic particles,

a plurality of actuators with magnetic elements distributed against the touch screen, and

means for activating each actuator for generating a local magnetic field in the touch screen.

This device comprises a screen thus capable of presenting tactile patterns easily and quickly reconfigurable by selective activation of the actuators, by acting on the changes in viscosity caused by local polarisations of the ferromagnetic particles that the screen contains.

Such a device is for example described in the patent application entitled “Tactile display apparatus using magneto-rheological fluid” and published under the number KR 10-2010-0138219. This device has a touch screen formed by a flexible latex layer hermetically covering a chamber filled with a magneto-rheological fluid. Electromagnets disposed against the chamber filled with fluid are activated individually in order to locally change the apparent viscosity of the magneto-rheological fluid by generating a local magnetic field, so that a tactile pattern sensation appears on the screen at the points where the viscosity is different. The layer of latex has a certain fragility, in particular risks of rupture. It is thus sensitive to external deteriorations that may cause flows of fluid making the device definitively unusable. Furthermore, the pattern is accessible to the touch, by accessing a sensation of variation in viscosity of the fluid through the latex layer, but does not have any relief.

Another device of this type is described in the article entitled “MudPad: tactile feedback and haptic texture overlay for touch surfaces”, by Jansen et al, published in ITL'10 Proceedings, ACM International Conference on Interactive Tabletops and Surfaces, 7-10 Nov. 2010, Saarbrücken (DE). In this device in the form of an interactive tablet, a matrix of electromagnets is also disposed at the rear of a screen hermetically containing a magneto-rheological fluid. This tablet is further sensitive to the touch: it is indicated that the texture of the screen is dynamically reconfigurable by activating the matrix of electromagnets. However, this table has the same drawbacks of fragility and absence of sensible or visible relief.

It may thus be wished to provide a tactile display device with a screen provided with ferromagnetic particles that dispenses with at least some of the aforementioned problems and constraints.

The subject matter of the invention is therefore a tactile display device comprising:

a touch screen comprising ferromagnetic particles,

a plurality of actuators with magnetic elements distributed against the touch screen, and

means for activating each actuator for generating a local magnetic field in the touch screen,

wherein the touch screen comprises an elastic flexible membrane formed in an elastomer material, this elastomer material comprising the ferromagnetic particles.

Thus, since the membrane is made from a flexible solid material, there is no risk of flow of fluid. There is also no need to provide a flexible hermetic layer such as latex. The touch screen is therefore both simpler to manufacture and less fragile than in the aforementioned examples.

Moreover, the effect of a magnetic field on a part of this touch screen is twofold. The locally modified rigidity of the membrane is sensitive to the touch, but it is also accentuated by an off-plane deformation of the elastic flexible membrane, making the touch screen locally deformable on activation of the actuators. Each tactile pattern thus created on the screen then has a sensible or even visible relief.

Optionally, the elastomer material is of the silicone or rubber type.

Optionally also:

each actuator comprises a movable element provided with a permanent magnet, and

the means for activating each actuator comprise means, in particular electromagnetic, for moving its movable element, between a position away from the touch screen and a position close to the touch screen, the latter position generating said local magnetic field.

In this case, a tactile display device according to the invention may comprise a matrix for locking the movable elements at at least three different functional positions:

a first unlocking functional position in which the movable elements are free to move between a high position and a low position,

a second locking functional position in which only the movable elements in the high position are held in the high position, the others being prevented from adopting this high position, and

a third display functional position in which the locking matrix carries, from the second locking position, the movable elements held in the high position against the touch screen.

Optionally also:

each actuator comprises an electromagnet disposed against the touch screen, and

the means for activating each actuator comprise means for the electrical control of its electromagnet, between an inactive state in which no local magnetic field is generated by the electromagnet and an active state in which said local magnetic field is generated by the electromagnet.

Optionally also, a tactile display device according to the invention may further comprise a set of sensors for sensing the position of at least one touch distributed against the touch screen.

Optionally also, the sensors comprise detectors for detecting local variations in resistivity in the elastic flexible membrane, in particular probes one end of which is contact with the elastic flexible membrane of the touch screen.

Optionally also, the plurality of actuators and the set of sensors are distributed regularly, in particular in a matrix fashion, in a support disposed against the touch screen.

Optionally also, the sensors comprise conductive wires extending in a regular fashion, in particular in a matrix fashion, in the thickness of the elastic flexible membrane made from elastomer of the touch screen.

Optionally, also, the plurality of actuators are distributed in a first matrix, the set of sensors is distributed in a second matrix, and the first and second matrices are disposed staggered with respect to each other in the support.

Optionally also, the ferromagnetic particles are chosen in soft magnetisation materials.

Optionally also, the ferromagnetic particles are chosen in hard magnetisation materials.

Optionally also, the touch screen further comprises an additional surface layer with a texture different from that of the elastic flexible membrane, added on top of the latter on an external face of the touch screen, this additional surface layer being in particular produced from an elastic plastics material or an elastic fabric deemed to be pleasant to the touch.

The invention will be better understood by means of the following description, given solely by way of example, and made with reference to the accompanying drawings, in which:

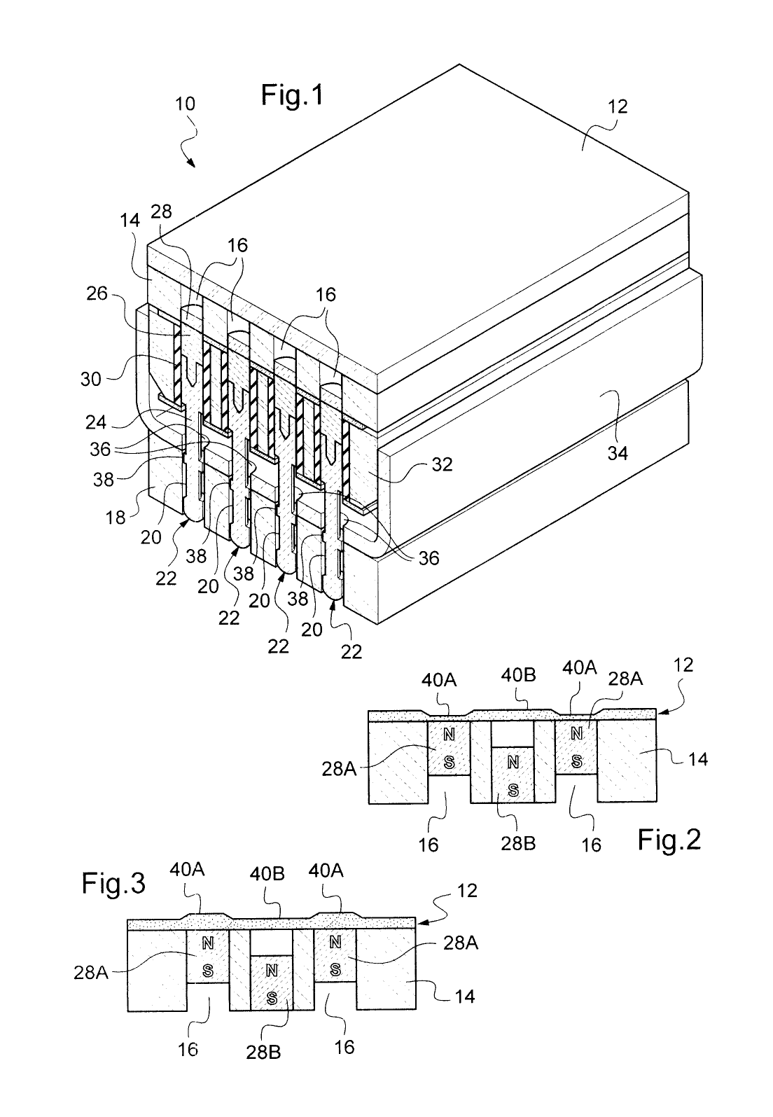

FIG. 1 shows schematically in a cross-section perspective the general structure of a tactile display device according to one embodiment of the invention,

FIG. 2 shows schematically in cross section a detail of the display device of FIG. 1, according to a first variant,

FIG. 3 shows schematically in cross section a detail of the display device of FIG. 1, according to a second variant,

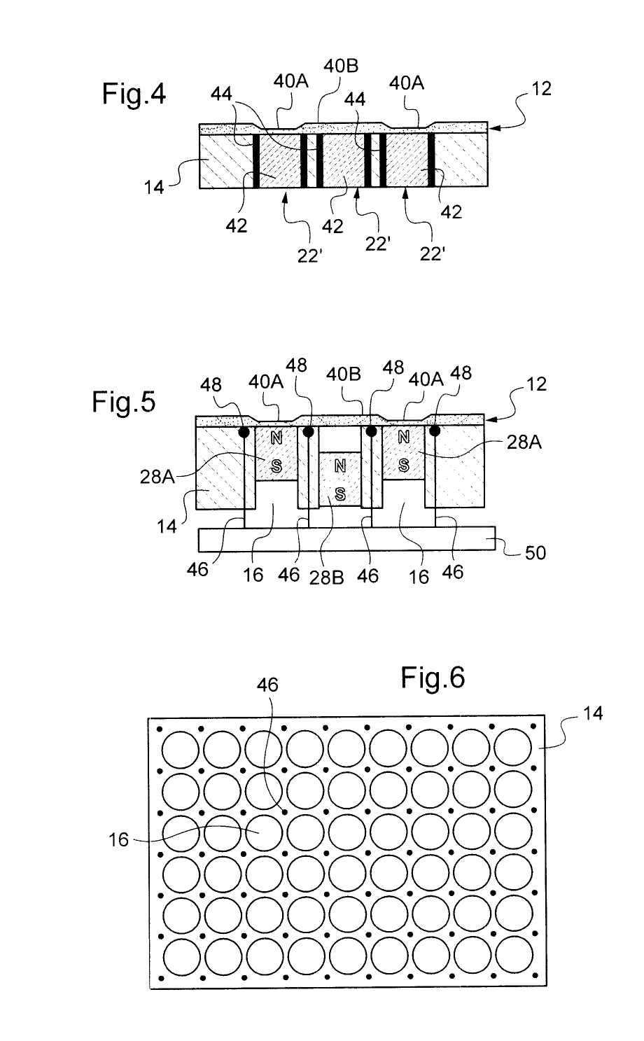

FIG. 4 shows schematically in cross section a detail of the display device of FIG. 1, according to a third variant

FIG. 5 shows schematically in cross section a detail of the display device of FIG. 1, according to a fourth variant

FIG. 6 shows schematically in plan view a touch-screen support of the device of FIG. 1, according to one embodiment of the invention, and

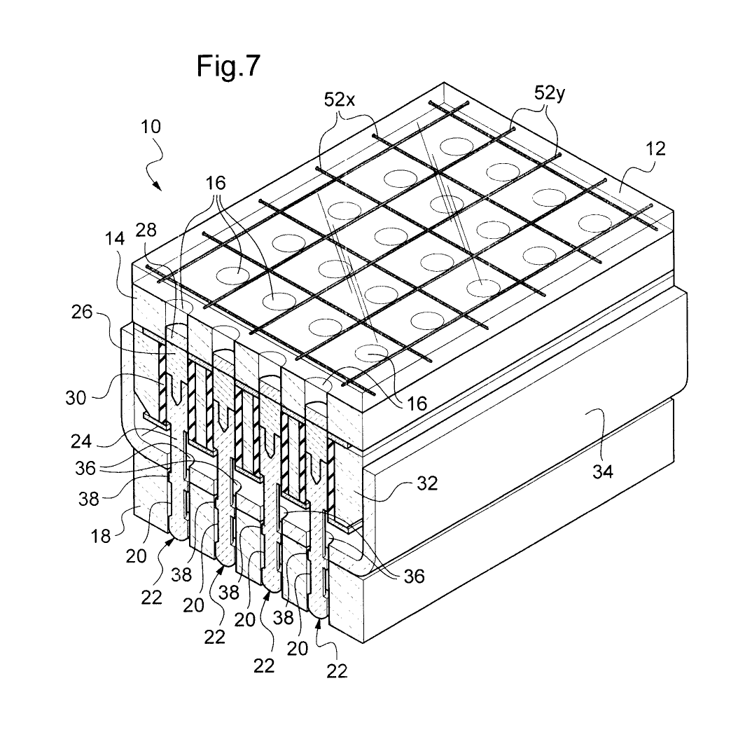

FIG. 7 shows schematically in a cross-section perspective the general structure of a tactile display device according to another embodiment of the invention.

A display device 10 with a touch screen 12 is shown in cross-section perspective in FIG. 1. This display device 10 is able to be integrated in a housing (not shown) of any form, to be adapted according to the application sought, pierced in one of its walls with a window intended to receive the touch screen 12. The latter is illustrated in rectangular flat form but may be adapted in any form.

More precisely, the touch screen 12 comprises or consists of an elastic flexible membrane formed in an elastomer material, for example silicone or rubber, this elastomer material comprising ferromagnetic particles. The ferromagnetic particles are for example chosen in soft magnetisation materials. The elastic flexible membrane, and therefore the touch screen 12, has a thickness that may range from a few tens of millimetres (at least 0.1 mm) to a few millimetres, for example 2 mm. Because of the presence of ferromagnetic particles actually in the elastomer material that constitutes it, the elastic flexible membrane of the touch screen 12 has magneto-rheological properties.

In concrete terms, in the presence of a local magnetic field in the vicinity of a certain area of the touch screen 12, generating for example field lines orthogonal to its surface, the ferromagnetic particles situated in this area have a tendency to be polarised all in the same direction, so that the rigidity of the touch screen 12 in this area is increased with respect to the other areas of the screen in which the local magnetic field has no effect. Furthermore, because the material containing the ferromagnetic particles is an elastomer rather than a fluid, the local magnetic field tends to deform the external face of the touch screen 12 in the area in question by attracting or repelling the ferromagnetic particles contained in the area concerned. The off-plane deformation thus obtained may reach a few fractions of a millimetre to a few millimetres, for example 1 mm for a thickness at rest of 2 mm.

For information on the constitution of or a method for manufacturing the elastic flexible membrane from elastomer material comprising ferromagnetic particles, reference can be made to the European patent published under the number EP 1 907 724.

The display device 10 also comprises a top frame 14, with the same general rectangular shape as the touch screen 12 and fixed, for example by adhesive bonding, against an internal face thereof. It fulfils a function of supporting the touch screen 12. It is pierced with through cylindrical holes 16 disposed in a matrix on a surface corresponding to the space occupied by the touch screen 12. The longitudinal principal axes of these through cylindrical holes 16 are perpendicular to the internal face of the touch screen 12.

The display device 10 also comprises a bottom frame 18, with the same rectangular general shape as the touch screen 12 and pierced with cylindrical holes 20, through or not, disposed facing the through cylindrical holes 16. The frames 14 and 18 may be extended by extensions (not shown) fixed together so as to create an available space between these two frames for receiving various elements constituting actuators 22 with movable elements of the display device 10.

Each of these actuators 22 comprises for example a core 24 with a cylindrical general shape consisting of iron, steel or a magnet, more generally a soft or hard ferromagnetic material. Each core 24 is surmounted by a cylindrical extension 26 made from insulating material. As illustrated in FIG. 1, this cylindrical extension 26 may be fixed to the core 24 by insertion. It is itself surmounted by a cylindrical permanent magnet 28 fixed by adhesive bonding. The assembly consisting of the core 24, its cylindrical extension 26 and the corresponding permanent magnet 28 forms the movable element of any one of the actuators 22, this movable element with a cylindrical general shape being guided in translation by the corresponding cylindrical holes 16 and 20 in which it is inserted. It therefore moves in a direction orthogonal to the surface of the touch screen 12.

The movable element 24, 26, 28 of each actuator 22 can be moved between at least two positions:

a first low position away from the touch screen 12, in which the local magnetic field generated by its permanent magnet 28 has little or no effect on the magneto-rheological elastic flexible membrane of the touch screen 12, and

a second high position close to the touch screen 12, in which the local magnetic field generated by its permanent magnet 28 has a locally sensible effect on the magneto-rheological elastic flexible membrane of the touch screen 12: more precisely, the membrane becomes more rigid locally and the external face of the touch screen tends to deform (off-plane).

In order to cause the movement of the movable elements 24, 26, 28 between their high and low positions, the actuators 22 also each comprise an electromagnet coil 30 disposed in the internal cylindrical wall of a corresponding through hole formed in an intermediate frame 32 fixed between the top and the bottom frames 14 and 18. This intermediate frame 32 is also pierced with through holes disposed in a matrix, each coil 30 disposed in one of its holes being controlled individually by an electric-current source (not shown) for individual movement of each movable element 24, 26, 28. The electric-current source fulfils the function of means for individual activation of the actuators 22.

Optionally but advantageously, a locking matrix 34 is provided in the display device 10. It is disposed free and guided in lateral translation on the bottom frame 18 and is pierced for example with circular or ovoid cylindrical holes 36 disposed in a matrix. Each movable element 24, 26, 28 of an actuator 22 then comprises, at the bottom part of its core 24, a collar 38 intended to cooperate with the locking matrix 34 in the following manner:

in a first unlocking position of the locking matrix 34, the movable elements 24, 26, 28 are centred on respective portions with a maximum cross section of the circular or ovoid cylindrical holes 36, in particular portions the cross section of which is greater than the diameter of the collars 38, so that the movable elements 24, 26, 28 are free in translation in the cylindrical holes 16 and 20,

in a second locking position of the locking matrix 34, the movable elements 24, 26, 28 are centred on respective portions with a minimum cross section of the circular or ovoid cylindrical holes 36, in particular portions the cross section of which is greater than the diameter of the collars 38, so that the movable elements 24, 26, 28 are held either in the high position or in the low position, without being able to return from one to the other.

The locking matrix 34 is also guided in vertical translation, that is to say in the direction of movement of the movable elements 24, 26, 28, to occupy a third so-called display position from its second locking position. More precisely, when passing from its locking position to its display position, according to a vertical bistability principle, the locking matrix 34 drives all the movable elements 24, 26, 28 in the high position upwards whereas all the movable elements in the low position remain as they stand. The movable elements in the high position 24, 26, 28 are then carried towards a new position in which their permanent magnets 28 come into contact with the internal face of the touch screen 12, that is to say in contact with its elastic flexible membrane made from magneto-rheological elastomer, thus creating the required rigid pattern in relief by the action of their respective local magnetic fields on the ferromagnetic particles of the membrane locally subjected to the effects of these fields.

By virtue of the locking matrix 34, the rigid pattern in relief can be held as long as required without the addition of any supplementary energy.

The top parts of the movable elements 24, 26, 28 of FIG. 1, namely the permanent magnets 28, in cooperation with the touch screen 12 and the upper frame 14 forming a support for the touch screen 12, will now be detailed according to two first possible variant embodiments illustrated in FIGS. 2 and 3.

According the first variant illustrated in FIG. 2, the permanent magnets are shown independently of the rest of the actuators 22 but remain secured to the cores 24 and their cylindrical extensions 26. Two permanent magnets 28A are shown in the high position (and in the third display position of the locking matrix 34, where applicable). Another permanent magnet 28B is shown in the low position. They are inserted in the through holes 16 of the rigid support constituted by the top frame 14.

The top faces of the permanent magnets 28A in the high position fit flush with the top face of the top frame 14, so that they come into contact with the internal face of the touch screen 12. Because of this, the local magnetic fields that they generate continuously have an effect on the corresponding areas 40A of the touch screen 12. In particular, if the ferromagnetic particles of the elastic flexible membrane are chosen in soft-magnetisation materials, they are attracted by the permanent magnets 28A in the high position so that, because these particles are embedded in an elastomer material, the touch screen 12 has less thickness and increased rigidity in the corresponding areas 40A. On the other hand, the areas 40B situated above the permanent magnets 28B in the low position preserve the thickness at rest of the touch screen 12.

The second variant illustrated in FIG. 3 is identical to that of FIG. 2, except that the ferromagnetic particles are chosen in hard-magnetisation materials. In this case, they are repelled (or attracted depending on the magnetisation) by the permanent magnets 28A in the high position so that, because these particles are embedded in an elastomer material, the touch screen 12 has increased thickness and rigidity in the corresponding areas 40A. On the other hand, the areas 40B situated above the permanent magnets 28B in the low position preserve the thickness at rest of the touch screen 12.

It will be noted that it is possible also to provide ferromagnetic particles chosen in soft-magnetisation materials in certain parts of the touch screen 12 and ferromagnetic particles chosen in hard-magnetisation materials in other parts of the touch screen 12.

According to a third variant illustrated in FIG. 4, the actuators 22 with movable elements in FIGS. 1, 2 and 3 are replaced by actuators 22′ with fixed elements. Each actuator 22′ thus comprises an electromagnet, that is to say a soft-iron core 42 surrounded by an electromagnet coil 44, inserted in one of the through holes 16 in the top frame 14. Each actuator 22′ is then in permanent contact with the internal face of the touch screen 12. On the other hand, such a fixed actuator 22′ has no local effect on the elastic flexible membrane made from magneto-rheological elastomer of the touch screen 12 unless it is activated by magnetisation of its coil 44 by means of a current source fulfilling the function of means of individual activation of the actuators 22′.

In the example illustrated in FIG. 4, the ferromagnetic particles are chosen in soft-magnetisation materials (or hard with an opposite magnetisation) and the first and second actuators 22′ are supplied with current, so that a local magnetic field is generated and the areas 40A of the touch screen 12 situated above these supplied actuators 22′ have less thickness and increased rigidity. On the other hand, the second actuator 22′, situated between the first and third actuators, is not supplied with current, so that the area 40B situated above this actuator 22′ keeps the thickness at rest of the touch screen 12.

According to a fourth variant illustrated in FIG. 5, envisaged from the first variant illustrated in FIG. 2, sensors 46 for the position of at least one touch are distributed against the internal face of the touch screen 12. More precisely, these sensors 46 may be in the form of wire probes passing through the thickness of the top frame 14, their respective free ends 48 coming into contact with the elastomer elastic flexible membrane of the touch screen 12, while their other respective ends are connected to a circuit 50 for detecting local variations in resistivity in the elastic flexible membrane. This is because, when a user places his finger on the external face of the touch screen 12, he deforms it locally by squashing, which causes a local variation in resistivity in the elastomer membrane provided with ferromagnetic particles. This local variation in resistivity being measurable in a manner known per se by the detection circuit 50 from the free end 48 of the probe closest to the deformation caused by the finger, it immediately becomes possible to be able to locate this touch. In this way, more generally, several touches, or even movements on the touch screen 12, can be detected.

The cross section illustrated in FIG. 5 presents a possible arrangement of the actuators and sensors, in alignment.

According to another possible embodiment illustrated in FIG. 6, in plan view of the top frame 14, it will be noted that the through cylindrical holes 16, and therefore the actuators 22 or 22′, are distributed regularly in a first matrix on the top frame 14. The sensors 46 are also distributed regularly in a second matrix on the top frame 14, this second matrix being disposed staggered with respect to the first. Other configurations can of course be envisaged.

In a variant, for detecting touch, it is also possible to replace the probes 46 passing through the top frame 14 with a matrix plate for the detection of local variations in resistivity, this plate being able to be inserted between the top face of the top frame 14 and the internal face of the touch screen 12. Such a variant is dealt with in the article “MudPad: tactile feedback and haptic texture overlay for touch surfaces” mentioned previously.

According to another embodiment that can be envisaged for detecting touch illustrated in FIG. 7, it is also possible to replace the probes 46 passing through the top frame 14 with a matrix of wire sensors 52x, 52y for detecting local variations in resistivity, this matrix being able to be integrated directly in the elastic flexible membrane made from magneto-rheological elastomer, that is to say embedded in the thickness of the touch screen 12. More precisely, the sensors 52x, 52y comprise conductive wires extending in a matrix fashion in the touch screen 12: the wire electric conductors 52x are disposed parallel in the touch screen 12 in a first principal direction of this screen so as to detect the position of a touch on a first X-axis; the wire electrical conductors 52y are disposed parallel in the touch screen 12 in a second principal direction of this screen, orthogonal to the first, so as to detect the position of a touch on a second Y-axis. The technical principle of such an embodiment is dealt with in detail in the article by Cheng et al, entitled “A novel highly-twistable tactile sensing array using extendable spiral electrodes” published in Proceedings of IEEE 22nd International Conference on Micro Electro Mechanical Systems, pages 92-95, 25-29 January 2009.

It is clear that a tactile display device such as the one described above according to various possible variant embodiments makes it possible to take advantage of the magneto-rheological properties of the touch screen in a simple and robust fashion, for an improved tactile or even visual effect. Moreover, the touch screen formed in a membrane made from magneto-rheological elastomer constitutes a protection of the actuation part of the display device.

In particular, the robustness of this device and its low manufacturing cost make it possible to envisage applications in the automobile sector, where manufacture takes place on a large scale. The particular advantage of this type of display device in an automobile is that it makes it possible to access driving or comfort functions simply without distracting the visual attention of the driver.

It should also be noted that the invention is not limited to the embodiments described above.

In particular, the upper part of the actuators, that is to say the permanent magnets or the electromagnets intended to be in contact with or in the vicinity of the internal face of the touch screen, does not necessarily have a circular cross section. In order to optimise the display of patterns on the touch screen, the cross section may be chosen so as to be rectangular, square, octagonal or other according to the applications envisaged.

In particular also, the touch screen 12 was described previously as consisting of an elastic flexible membrane. However, the touch screen may also comprise for example an additional surface layer, in other words a thin “skin”, with a texture different from that of the elastic flexible membrane, added above the latter, that is to say on the external face of the touch screen, in order to improve the man-machine interaction. This skin may be produced from an elastic plastics material or an elastic fabric deemed to be pleasant to the touch.

It will be clear more generally to a person skilled in the art that various modifications can be made to the embodiments described above, in the light of the teaching that has just been disclosed to him. In the following claims, the terms used must not be interpreted as limiting the claims to embodiments disclosed in the present description but must be interpreted in order to include therein all the equivalents that the claims aim to cover because of their formulation and the provision of which is within the scope of a person skilled in the art applying his general knowledge to the implementation of the teaching that has just been disclosed to him.

1-13. (canceled)

14. A tactile display device comprising:
a touch screen including ferromagnetic particles;
a plurality of actuators including magnetic elements distributed against the touch screen;
means for activating each actuator to generate a local magnetic field in the touch screen; and
an elastic membrane formed in an elastomer flexible solid material, the elastomer material including the ferromagnetic particles.

15. A tactile display device according to claim 14, wherein the elastomer material is of silicone or rubber type.

16. A tactile display device according to claim 14, wherein:
each actuator includes a movable element including a permanent magnet, and
the means for activating each actuator includes means for moving its movable element between a position away from the touch screen and a position close to the touch screen, the position close to the touch screen generating the local magnetic field.

17. A tactile display device according to claim 16, further comprising a matrix for locking the movable elements at at least three different functional positions of:
a first unlocking functional position in which the movable elements are free to move between a high position and a low position,
a second locking functional position in which only the movable elements in the high position are held in the high position, the other movable elements being prevented from adopting the high position, and
a third display functional position in which the locking matrix carries, from the second locking position, the movable elements held in the high position against the touch screen.

18. A tactile display device according to claim 14, wherein:
each actuator includes an electromagnet disposed against the touch screen, and
the means for activating each actuator includes means for electrical control of its electromagnet, between an inactive state in which no local magnetic field is generated by the electromagnet and an active state in which the local magnetic field is generated by the electromagnet.

19. A tactile display device according to claim 14, further comprising a set of sensors for sensing a position of at least one touch distributed against the touch screen.

20. A tactile display device according to claim 19, wherein the sensors include detectors for detecting local variations in resistivity in the elastic flexible membrane, or probes including one end in contact with the elastic flexible membrane of the touch screen.

21. A tactile display device according to claim 19, wherein the plurality of actuators and the set of sensors are distributed in a regular fashion, or in a matrix fashion, in a support disposed against the touch screen.

22. A tactile display device according to claim 19, wherein the sensors include conductive wires extending in a regular fashion, or in a matrix fashion, in a thickness of the elastomer elastic flexible membrane of the touch screen.

23. A tactile display device according to claim 21, wherein the plurality of actuators are distributed in a first matrix, the set of sensors is distributed in a second matrix, and the first and second matrices are disposed staggered with respect to each other in the support.

24. A tactile display device according to claim 14, wherein the ferromagnetic particles are chosen in soft-magnetisation materials.

25. A tactile display device according to claim 14, wherein the ferromagnetic particles are chosen in hard-magnetization materials.

26. A tactile display device according to claim 14, wherein the touch screen further includes an additional surface layer with a texture different from that of the elastic flexible membrane, added above the elastic flexible membrane on an external face of the touch screen, the additional surface layer being produced from an elastic plastics material or an elastic fabric deemed to be pleasant to a touch.
